(19) United States
(12) Patent Application Publication
(10) Pub. No.: US 2007/0204141 A1
(43) Pub. Date: Aug. 30, 2007

(54) RECORDING MEDIUM, DATA MANAGEMENT METHOD, AND PROGRAM

(75) Inventors: Hirofumi YAMAGUCHI, Osaka (JP); Mayumi TAKIMOTO, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/668,100

(22) Filed: Jan. 29, 2007

(30) Foreign Application Priority Data
Feb. 27, 2006 (JP) 2006/051246
Jan. 15, 2007 (JP) 2007/005916

(51) Int. Cl. G06F 9/44; G06F 15/00

(52) U.S. Cl. 712/228

(57) ABSTRACT

The invention provides a removable medium capable of suitably managing digital images, music, and/or data with a specified use rule. An SD card is insertable into/removable from plural host apparatuses and includes digital data recorded therein. The SD card includes an expiration date determination processing unit for determining whether or not the digital data is usable based on, for example, an expiration date, and a deletion processing unit for deleting the digital data when it is determined that the digital data is unusable, that is, the digital data has expired. The SD card autonomously makes determination whether or not digital data recorded therein is usable and deletion of the digital data without control by a host apparatus having the SD card inserted thereinto, except supply of power and clocks from the host apparatus.

### BACKGROUND OF THE INVENTION

(1) Field of the Invention

The present invention relates to a recording medium which is insertable into/removable from plural host apparatuses and includes digital data recorded therein. In particular, the present invention relates to a technique for managing the digital data with a specified use rule. Such contents include image, music, and data.

(2) Description of the Related Art

Recently, network speeds have been improved, and hard disks and removable mediums have grown in capacity. Therefore, contents that are digital images, sounds and/or data are traded on the networks and are readily available to users.

Popularization of portable recording mediums insertable into/removable from plural host apparatuses (hereinafter, simply referred to as “removable medium”) makes it possible for users to readily carry data obtained from a network. However, unauthorized copying of such data has increased. Therefore, there is a need to encourage copyright protection and security enhancement.

In order to overcome this disadvantage, for example, a method of providing a use rule (i.e., access limit) for contents to be recorded in a removable medium and deleting unusable contents from the removable medium may be employed.

FIG. 1 is a block diagram illustrating a functional structure of a conventional removable medium and a functional structure of a conventional host apparatus, upon deletion of data from the removable medium.

A removable medium 101 is insertable into/removable from plural host apparatuses, and includes a recording area 102 where data can be recorded.

A host apparatus 103 includes the removable medium 101 insertable thereinto, and includes a search/determination processing unit 104 for determining whether or not data recorded in the removable medium 101 has expired, and a deletion processing unit 105 for deleting contents.

It is herein assumed that an expiration date is provided as a use rule for using data. Conventionally, when the removable medium 101 is inserted into the host apparatus 103, the search/determination processing unit 104 of the host apparatus 103 searches for data in the recording area 102 and determines whether or not the data in the recording area 102 has expired. When expired data is recorded in the recording area 102, the deletion processing unit 105 of the host apparatus 103 issues a deletion command to the removable medium 101; thus, the expired data is deleted from the removable medium 101.

The aforementioned method is well known. For example, Japanese Patent Application No. 2001-30863 discloses the following technique. That is, an expiration date is provided to contents to be recorded (checked out) in a removable medium. If the data has expired at a time when the removable medium is inserted into a host apparatus, the host apparatus deletes the data. In other words, a host apparatus other than a host apparatus actually recording data in a removable medium can delete the contents from the removable medium.

According to the conventional technique, however, in order to delete data which is unusable after the expiration of the expiration date, there is a need for a host apparatus having data editing functions including at least a data deleting function. Consequently, a user having only a playback-only apparatus (player) cannot delete such unusable data by himself/herself. That is, there is a disadvantage that the user keeps carrying the unusable data.

Moreover, since the host apparatus determines whether or not contents have expired, there is a possibility that a program in the host apparatus is tampered with in order to create a security hole by which even expired contents can be used normally.

### SUMMARY OF THE INVENTION

The present invention has been devised in view of the aforementioned circumstances, and has an object to provide a removable medium capable of suitably managing image, music, and/or data with a specified use rule.

In order to accomplish this object, a recording medium according to the present invention is insertable into and/or removable from plural host apparatuses and includes digital data recorded therein. The recording medium includes a determination unit which determines whether or not the digital data is usable, and a deletion unit which deletes the digital data when it is determined that the digital data is unusable.

Herein, the determination unit can determine whether or not the digital data is usable, based on at least one of, for example, an expiration date of the digital data, the number of usable times of the digital data, a fact whether or not the digital data is recorded in an unauthorized manner, and a fact whether or not the digital data is corrupted.

In addition, the determination unit may make the determination when the recording medium receives operating power, and the deletion unit may perform the deletion prior to a first response to an external access request. Alternatively, the determination unit may make the determination upon acceptance of an external access request, and the deletion unit may perform the deletion prior to a response to the access request. More preferably, the determination unit may make the determination periodically during a period in which the recording medium receives operating power.

The recording medium may have management information indicating the digital data recorded therein, and the deletion unit may edit the management information upon deletion of the digital data.

The recording medium including the determination unit and the deletion unit automatically deletes the digital data without a manual operation by a user. Therefore, there is a possibility that the user is confused.

In order to avoid the confusion, preferably, the recording medium further includes a recording unit, when the deletion unit deletes digital data, which records deletion information including an identification name, use rule, and date of the deletion of the deleted digital data, or a recording unit, when the determination unit determines whether or not the digital data is usable, which records determination information including an identification name, use rule, date of the determination, and a result of the determination of the determined digital data. The recording unit may add the deletion information to the management information.

The recording medium may further include a notification unit, when the deletion unit deletes digital data, which notifies a host apparatus, into which the recording medium is inserted, of deletion information including an identification name, use rule, and date of the deletion of the deleted digital data. In this structure, it is also possible to attain an effect of avoiding the aforementioned disadvantage.

The present invention can be realized by not only such a recording medium, but also a data management method performed by the recording medium and a program executed by a computer in the recording medium.

According to the present invention, a removable medium autonomously determines whether or not data is usable to delete unusable data only by insertion into a host apparatus which supplies operating power thereto. Therefore, even when a user only has a host apparatus of a playback-only type having no function of editing data in a removable medium, unnecessary data can be automatically deleted from the removable medium without an effort to manually delete the unnecessary data by the user.

As a result, the removable medium can have a spare capacity kept at maximum constantly; thus, a recording area for new data is secured favorably.

In addition, unnecessary data is deleted without control of a host apparatus except supply of operating power. Therefore, it is possible to protect copyright from infringement more firmly.

Further, deletion information or determination information upon deletion of data is stored in the removable medium and the host apparatus can receive such information. With this structure, it is possible to prevent a user from confusion due to automatic deletion of data.

### FURTHER INFORMATION ABOUT TECHNICAL BACKGROUND TO THIS APPLICATION

The disclosure of Japanese Patent Application No. 2006-051246 filed on Feb. 27, 2006 including specification, drawings and claims is incorporated herein by reference in its entirety.

The disclosure of Japanese Patent Application No. 2007-005916 filed on Jan. 15, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram illustrating a structure of a host apparatus and a structure of an SD card in a first embodiment of the present invention;

FIG. 2 is a flowchart showing an operating procedure of the host apparatus in the first embodiment of the present invention;

FIG. 3 is a flowchart showing an operating procedure of the SD card in the first embodiment of the present invention;

FIG. 4 is a flowchart showing an operating procedure of an SD card in a second embodiment of the present invention;

FIG. 5 shows timings of data deletion in the first and second embodiments of the present invention;

FIG. 6 is a block diagram illustrating a structure of a host apparatus and a structure of an SD card in a third embodiment of the present invention;

FIG. 7 is a flowchart showing an operating procedure of the SD card in the third embodiment of the present invention;

FIG. 8 is a flowchart showing an operating procedure of an SD card in a fourth embodiment of the present invention;

FIG. 9 is a block diagram illustrating a structure of a host apparatus and a structure of an SD card in a fifth embodiment of the present invention;

FIG. 10 is a flowchart showing an operating procedure of the SD card in the fifth embodiment of the present invention;

FIG. 11 is a block diagram illustrating a structure of a host apparatus and a structure of an SD card in a sixth embodiment of the present invention;

FIG. 12 is a flowchart showing an operating procedure of the SD card in the sixth embodiment of the present invention;

FIG. 13 is a block diagram illustrating a structure of a host apparatus and a structure of an SD card in a seventh embodiment of the present invention;

FIG. 14 is a flowchart showing an operating procedure of the SD card in the seventh embodiment of the present invention;

FIG. 15 shows an example of a content deletion information file in the seventh embodiment of the present invention;

FIG. 16 is a flowchart showing an operating procedure of an SD card in an eighth embodiment of the present invention;

FIG. 17 shows an example of a content determination information file in the eighth embodiment of the present invention;

FIG. 18 is a block diagram illustrating a structure of a host apparatus and a structure of an SD card in a ninth embodiment of the present invention;

FIG. 19 is a flowchart showing an operating procedure of the host apparatus in the ninth embodiment of the present invention;

FIG. 20 is a flowchart showing an operating procedure of the SD card in the ninth embodiment of the present invention; and

FIG. 21 illustrates a structure of a conventional removable medium and a structure of a conventional host apparatus, upon deletion of data from the removable medium.

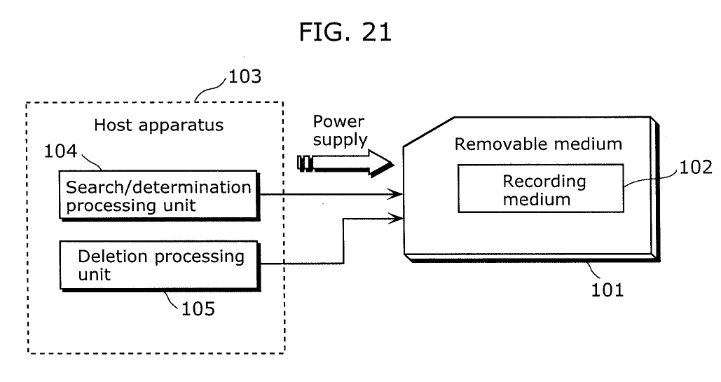

### DESCRIPTION OF THE PREFERRED EMBODIMENTS

Hereinafter, detailed description will be given of preferred embodiments, each regarding deletion of digital data recorded in a removable medium according to the present invention, with reference to the drawings.

### First Embodiment

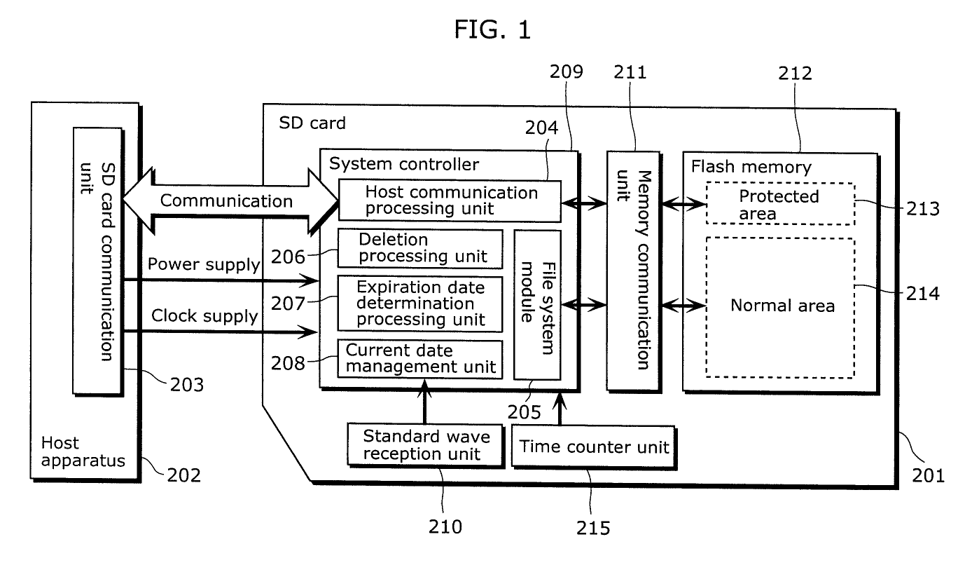

FIG. 1 is a block diagram illustrating a functional structure of an SD memory card (hereinafter, referred to as “SD card”) 201 in a first embodiment of the present invention. FIG. 1 also illustrates a host apparatus 202 having the SD card 201 insertable thereinto, in addition to the SD card 201.

The SD card 201 autonomously determines whether or not digital data recorded therein is usable, and deletes the digital data when it is determined that the digital data is unusable.

Herein, the term autonomous means that the SD card 201 independently make the determination and the deletion without receiving information indicating the determination and information indicating the deletion from a host apparatus into which the SD card 201 is inserted. The information indicating the determination is, for example, current date to be compared with an expiration date of digital data, and the information indicating the deletion is, for example, command information for instructing execution of deletion.

The SD card 201 receives power and clocks or only power from a host apparatus into which the SD card 201 is inserted, thereby to make autonomous determination and autonomous deletion, which is a feature of the present invention.

In the host apparatus 202, an SD card communication unit 203 detects insertion of the SD card 201, and supplies power and clocks to the inserted SD card 201. Then, the SD card communication unit 203 communicates with the SD card 201 and issues a command to the SD card 201; thus, data is read from/written to the SD card 201.

As illustrated in FIG. 1, the SD card 201 includes a system controller 209, a standard wave reception unit 210, a time counter unit 215, a memory communication unit 211 and a flash memory 212.

The flash memory 212 stores data in a nonvolatile manner. The flash memory 212 is divided into two areas: a normal area 214 and a protected area 213 each storing different kinds of data. The normal area 214, which the host apparatus 202 can access, stores music data. The protected area 213, which the host apparatus 202 cannot access directly, stores expiration dates of all pieces of music data stored in the normal area 214. In the following description, “digital data” in claims of the present invention corresponds to the music data.

The system controller 209 is activated by power and clocks each supplied from the SD card communication unit 203, and controls the SD card 201 entirely.

In the system controller 209, a host communication processing unit 204 analyzes a command issued from the SD card communication unit 203 and communicates with the memory communication unit 211 in accordance with details of the command; thus, the host apparatus 202 can access the flash memory 212.

Through an operation by a file system module 205, data in the flash memory 212 can be recognized as a file.

A deletion processing unit 206 accesses the normal area 214 of the flash memory 212 through the file system module 205 to delete a music data file.

An expiration date determination processing unit 207 accesses the protected area 213 of the flash memory 212 through the file system module 205 to acquire an expiration date of any piece of the music data. Then, the expiration date determination processing unit 207 compares the expiration date with a current date acquired from a current date management unit 208, thereby to determine whether or not the relevant music data is usable. Herein, music data determined as unusable data is regarded as data to be deleted.

The current date management unit 208 acquires a current date from the standard wave reception unit 210, and notifies the expiration date determination processing unit 207 of the current date.

The standard wave reception unit 210 acquires a current date based on a received standard wave for time tone, and notifies the current date management unit 208 of the current date.

The memory communication unit 211 accesses the normal area 214 and the protected area 213 in the flash memory 212 to read/write data from/to each area.

The time counter unit 215 can measure a fixed time, and notifies the system controller 209 of a lapse of an arbitrary time.

In the aforementioned structure, the SD card 201, the expiration date determination processing unit 207 and the deletion processing unit 206 respectively correspond to “a recording medium”, “a determination unit” and “a deletion unit” in claims of the present invention.

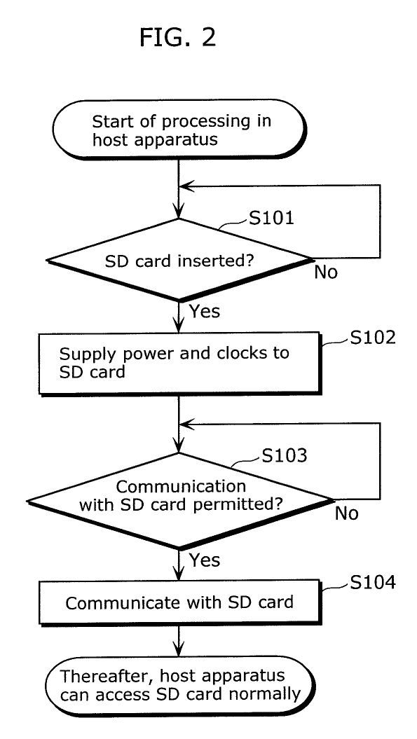

Next, description will be given of a procedure of processing executed by the host apparatus 202 in this embodiment with reference to a flowchart in FIG. 2.

In Step S101, first, the host apparatus 202 enters an SD card insertion standby state. When the SD card 201 is inserted into the host apparatus 202, the processing proceeds to Step S102. In Step S102, the SD card communication unit 203 supplies power and clocks to the inserted SD card 201. Subsequently, the processing enters a loop until the SD card 201 transmits communication permission information to the host apparatus 202. In Step S103, the host apparatus 202 enters a communication permission information reception standby state. Upon reception of the communication permission information from the SD card 201, thereafter, the host apparatus 202 can communicate with the SD card 201.

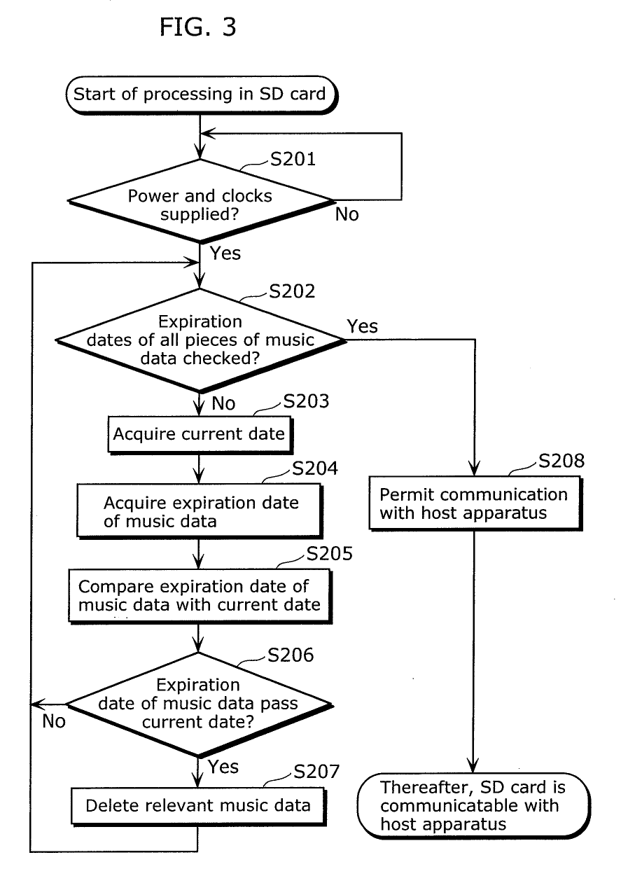

Next, description will be given of a procedure of processing executed by the SD card 201 with reference to a flowchart in FIG. 3.

In Step S201, first, the SD card 201 enters a power/clock reception standby state. When the SD card 201 is inserted into the host apparatus 202, thereby to receive power and clocks, the system controller 209 is activated. Then, the system controller 209 compares a current date with each of expiration dates of all pieces of music data stored in the normal area 214 of the flash memory 212. If there is music data with an expiration date passing the current date, the system controller 209 determines that the music data is unusable and deletes the music data. The host communication processing unit 204 ignores an access command issued from the SD card communication unit 203 until the expiration dates of all pieces of music data are determined and communication permission information is transmitted to the host apparatus 202.

In Step S202, next, the expiration date determination processing unit 207 determines whether or not the expiration dates of all pieces of music data are determined. If there is undetermined music data, the processing proceeds to Step S203.

In Step S203, the current date management unit 208 acquires a current date from the standard wave reception unit 210 and notifies the expiration date determination processing unit 207 of the current date. In Step S204, next, the expiration date determination processing unit 207 accesses the protected area 213 through the file system module 205 to acquire the expiration date of the relevant music data. In Step S205, next, the expiration date determination processing unit 207 compares the current date with the acquired expiration date. If it is determined that the expiration date passes the current date, the processing proceeds to Step S207. In Step S207, the expiration date determination processing unit 207 determines that the music data is unusable, regards the music data as data to be deleted, and notifies the deletion processing unit 206 of the location of the music data to be deleted in form of, for example, a file name.

The deletion processing unit 206 deletes the notified music data from the normal area 214 through the file system module 205. If it is determined that the expiration date does not pass the current date, the expiration date determination processing unit 207 determines that the music data is usable and the processing returns to Step S202. In Step S202, comparison for subsequent music data is performed. After completion of determining the expiration dates of all pieces of music data in Step S202, the processing proceeds to Step S208. In Step S208, the host communication processing unit 204 transmits communication permission information to the host apparatus 202. Thereafter, the SD card 201 accepts a command issued from the SD card communication unit 203.

Thus, even when expired music data is stored in an SD card, the SD card can determine that the expired music data is unusable and delete the music data before communication with a host apparatus.

In this embodiment, as an example, digital data to be stored in an SD card is music data; however, the present invention is not limited thereto. The present invention is applicable to all kinds of digital data. Also in this embodiment, a current date is acquired based on a standard wave. However, the current date may be retained using a battery backup unit.

### Second Embodiment

In a second embodiment of the present invention, a structure of an SD card 201 and a structure of a host apparatus 202 having the SD card 201 insertable thereinto are identical to those described in the first embodiment with reference to FIG. 1.

A procedure of processing executed by the host apparatus 202 in this embodiment is identical to that described in the first embodiment; therefore, specific description thereof will not be given here.

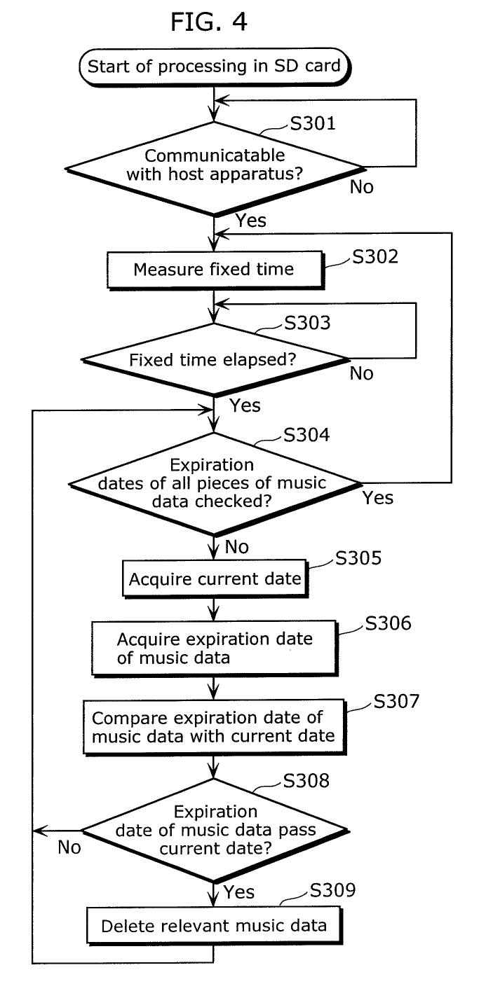

Description will be given of a procedure of processing executed by the SD card 201 in this embodiment with reference to a flowchart in FIG. 4.

When the SD card 201 is inserted into the host apparatus 202, expiration dates of all pieces of music data are determined as in the first embodiment. After completion of the determination, the SD card 201 can communicate with the host apparatus 202.

When the SD card 201 can communicate with the host apparatus 202 in Step S301, the processing proceeds to Step S302. In Step S302, a time counter unit 215 sets a timer for measuring time at an hour interval. After a lapse of one hour in Step S303, the time counter unit 215 notifies an expiration date determination processing unit 207 of the lapse of one hour. Then, the expiration date determination processing unit 207 performs a usable/unusable determining process based on determination of expiration dates of all pieces of music data.

In Step S304, the expiration date determination processing unit 207 determines whether or not the expiration dates of all pieces of music data are determined. If there is undetermined music data, the processing proceeds to Step S305.

In Step S305, a current date management unit 208 acquires a current date from a standard wave reception unit 210 and notifies the expiration date determination processing unit 207 of the current date. In Step S306, next, the expiration date determination processing unit 207 accesses a protected area 213 through a file system module 205 to acquire an expiration date of the relevant music data. In Step S307, next, the expiration date determination processing unit 207 compares the current date with the acquired expiration date. If it is determined that the expiration date passes the current date in Step S308, the processing proceeds to Step S309. In Step S309, the expiration date determination processing unit 207 determines that the music data is unusable, regards the music data as data to be deleted, and notifies a deletion processing unit 206 of the location of the music data to be deleted.

The deletion processing unit 206 deletes the notified music data from a normal area 214 through the file system module 205. If it is determined that the expiration date does not pass the current date, the expiration date determination processing unit 207 determines that the music data is usable and the processing returns to Step 5304. In Step S304, comparison for subsequent music data is performed. After completion of determining the expiration dates of all pieces of music data in Step S304, the processing proceeds to Step S302. In Step S302, the time counter unit 215 sets the timer for one hour and measures a time again. Thereafter, by repetition of the aforementioned processing, the SD card 201 inserted into the host apparatus 202 can delete expired music data recorded therein, without control of the host apparatus 202.

In this embodiment, as an example, a time interval for determining an expiration date of music data is one hour. However, this time interval may be set arbitrarily. Also in this embodiment, as an example, contents to be stored in an SD card are music data; however, the present invention is not limited thereto. The present invention is applicable to all kinds of digital data.

As described above, autonomous deletion of music data is performed upon start of reception of operating power (first embodiment) and is performed periodically during reception of operating power (second embodiment).

Additionally, it is possible to consider a modification that if a host apparatus issues an access request for expired music data to an SD card, the SD card deletes the music data prior to a response to the access request.

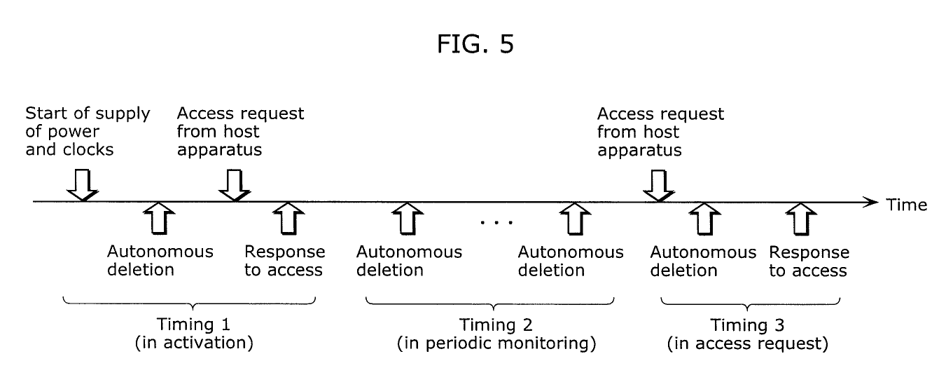

FIG. 5 shows all the above-described timings of deletion.

In FIG. 5, a portion at Timing 1 corresponds to the description in the first embodiment. That is, upon reception of operating power, an SD card starts to perform autonomous deletion. After completion of the autonomous deletion, the SD card can accept and respond to an access request from a host apparatus.

Also in FIG. 5, a portion at Timing 2 corresponds to the description in the second embodiment. That is, an SD card performs periodic monitoring during reception of operating power, thereby to perform autonomous deletion.

Also in FIG. 5, a portion at Timing 3 corresponds to the aforementioned modification. That is, in accordance with an access request from a host apparatus, an SD card performs autonomous deletion. After completion of the autonomous deletion, the SD card responds to the access request.

### Third Embodiment

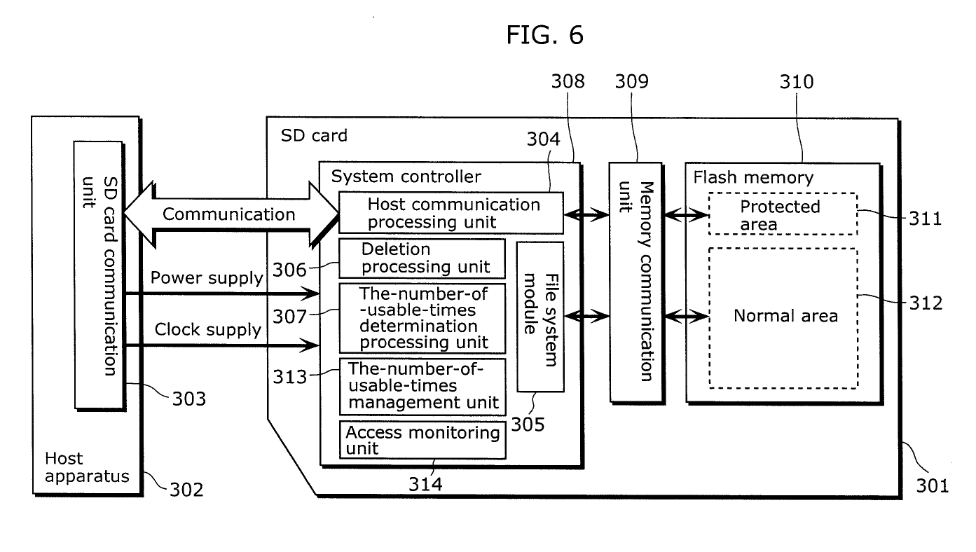

FIG. 6 is a block diagram illustrating a functional structure of an SD card 301 in a third embodiment of the present invention and a functional structure of a host apparatus 302 having the SD card 301 insertable thereinto.

In the host apparatus 302, an SD card communication unit 303 detects insertion of the SD card 301, and supplies power and clocks to the inserted SD card 301. Then, the SD card communication unit 303 communicates with the SD card 301 and issues a command to the SD card 301; thus, data is read from/written to the SD card 301.

As illustrated in FIG. 6, the SD card 301 includes a system controller 308, a memory communication unit 309 and a flash memory 310.

The flash memory 310 stores data in a nonvolatile manner. The flash memory 310 is divided into two areas: a normal area 312 and a protected area 311 each storing different kinds of data. The normal area 312, which the host apparatus 302 can access, stores music data. The protected area 311, where the host apparatus 302 cannot access directly, stores the numbers of usable times of all pieces of music data stored in the normal area 312.

The system controller 308 is activated by power and clocks each supplied from the SD card communication unit 303, and controls the SD card 301 entirely.

In the system controller 308, a host communication processing unit 304 analyzes a command issued from the SD card communication unit 303 and communicates with the memory communication unit 309 in accordance with details of the command; thus, the host apparatus 302 can access the flash memory 310.

Through an operation by a file system module 305, data in the flash memory 310 can be recognized as a file.

A deletion processing unit 306 accesses the normal area 312 of the flash memory 310 through the file system module 305 to delete a music data file.

A the-number-of-usable times determination processing unit 307 accesses the protected area 311 of the flash memory 310 through the file system module 305 to acquire the number of usable times of music data. The the-number-of-usable-times determination processing unit 307 determines the number of usable times, thereby to determine whether or not the relevant music data is usable.

A the-number-of-usable-times management unit 313 accesses the protected area 311 of the flash memory 310 through the file system module 305 to acquire the number of usable times of used music data. Then, the-number-of-usable-times management unit 313 decrements the acquired number of usable times and writes back the decremented number of usable times to the protected area 311 of the flash memory 310.

An access monitoring unit 314 monitors whether or not the host apparatus 302 issues playback start access or playback completion access to music data stored in the normal area 312 of the flash memory 310.

The memory communication unit 309 accesses the protected area 311 and the normal area 312 in the flash memory 310 to read/write data from/to each area.

In the aforementioned structure, the SD card 301, the the-number-of-usable-times determination processing unit 307 and the deletion processing unit 306 respectively correspond to “a recording medium”, “a determination unit” and “a deletion unit” in claims of the present invention.

A procedure of processing executed by the host apparatus 302 in this embodiment is identical to that described in the first embodiment; therefore, specific description thereof will not be given here.

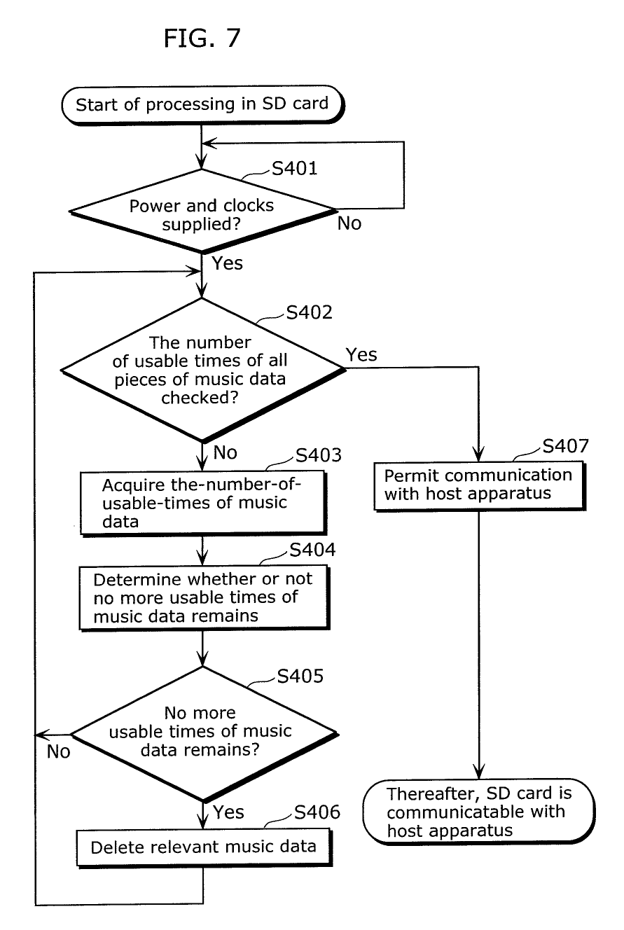

Description will be given of a procedure of processing executed by the SD card 301 in this embodiment with reference to a flowchart in FIG. 7.

When the SD card 301 is inserted into the host apparatus 302, thereby to receive power and clocks, the system controller 308 is activated. Then, the system controller 308 determines whether or not no more usable times (uses) remains for each piece of music data stored in the normal area 312 of the flash memory 310. If there is music data which is usable, the system controller 308 determines that the music data is unusable and deletes the music data. The host communication processing unit 304 ignores an access command issued from the SD card communication unit 303 until the numbers of usable times of all pieces of music data are determined and communication permission information is transmitted to the host apparatus 302.

In Step S402, first, the the-number-of-usable-times determination processing unit 307 determines whether or not the numbers of usable times of all pieces of music data are determined. If there is undetermined music data, the processing proceeds to Step S403.

In Step S403, the the-number-of-usable-times determination processing unit 307 accesses the protected area 311 through the file system module 305 to acquire the number of usable time of the relevant music data. In Steps S404 and S405, next, the the-number-of-usable-times determination processing unit 307 determines whether or not no more usable times remains. If it is determined that no more usable times remains, the processing proceeds to Step S406. In Step S406, the the-number-of-usable-times determination processing unit 307 determines that the music data is unusable, regards the music data as data to be deleted, and notifies the deletion processing unit 306 of the location of the music data to be deleted.

The deletion processing unit 306 deletes the notified music data from the normal area 312 through the file system module 305. After deletion of the music data, the processing returns to Step S402. In Step S402, the aforementioned processes are executed on subsequent music data. On the other hand, if it is determined in Step S405 that usable times (use) remain, the the-number-of-usable-times determination processing unit 307 determines that the music data is usable and the processing returns to Step S402. In Step S402, the aforementioned processes are executed on subsequent music data.

After completion of determining the numbers of usable times of all pieces of music data in Step S402, the processing proceeds to Step S407. In Step S407, the host communication processing unit 304 transmits communication permission information to the host apparatus 302. Thereafter, the SD card 301 accepts a command issued from the SD card communication unit 303.

Thus, even when music data which is usable is stored in an SD card, the SD card can delete the music data before communication with a host apparatus.

In this embodiment, as an example, digital data to be stored in an SD card is music data; however, the present invention is not limited thereto. The present invention is applicable to all kinds of digital data with the number of usable times.

### Fourth Embodiment

In a fourth embodiment of the present invention, a structure of an SD card 301 and a structure of a host apparatus 302 having the SD card 301 inserted thereinto are identical to those described in the third embodiment with reference to FIG. 6; therefore, specific description thereof will not be given here.

A procedure of processing executed by the host apparatus 302 in this embodiment is identical to that described in the first embodiment; therefore, specific description thereof will not be given here.

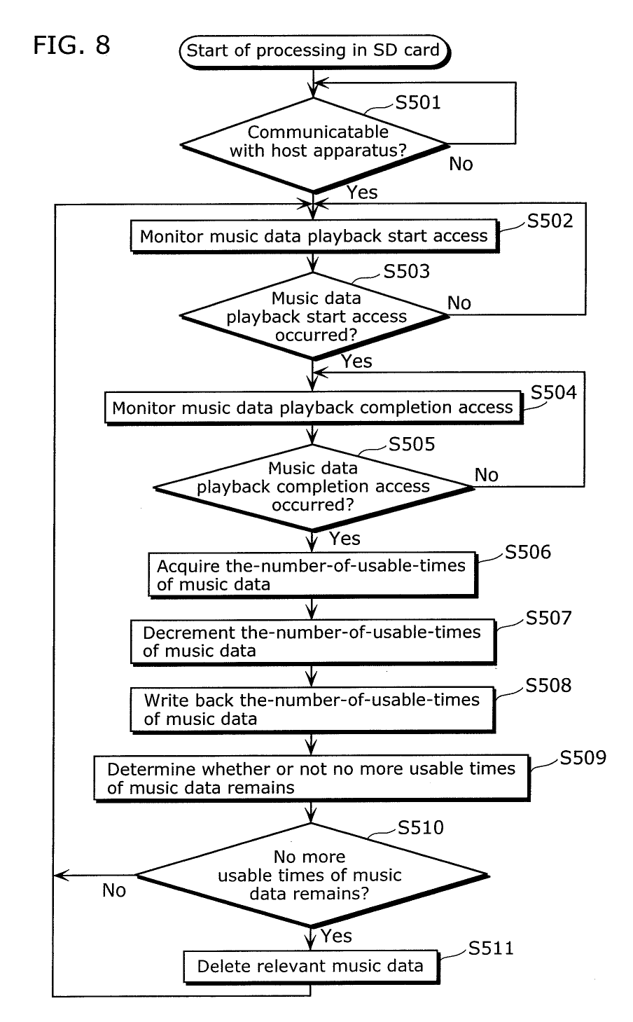

Description will be given of a procedure of processing executed by the SD card 301 in this embodiment with reference to a flowchart in FIG. 8.

First, when the SD card 301 is inserted into the host apparatus 302, the numbers of usable times of all pieces of music data are determined as in the third embodiment. After completion of the determination, the SD card 301 can communicate with the host apparatus 302.

When the SD card 301 can communicate with the host apparatus 302, the processing proceeds to Step S502. In Step S502, an access monitoring unit 314 monitors music data playback start access from the host apparatus 302. In Step S503, if it is determined that the host apparatus 302 issues the music data playback start access, the processing proceeds to Step S504. In S504, the access monitoring unit 314 monitors music data playback completion access. Herein, the host apparatus 302 plays back the relevant music data. When the host apparatus 302 issues the music data playback completion access, it is determined in Step S505 that the music data playback completion access occurs. Then, the processing proceeds to Step S506.

The the-number-of-usable-times determination processing unit 307 accesses a protected area 311 through a file system module 305 to acquire the number of usable times of the relevant music data. In Step S507, next, a the-number-of-usable-times management unit 313 decrements the number of usable times acquired by the the-number-of-usable-times determination processing unit 307. In Step S508, the the-number-of-usable-times management unit 313 accesses the protected area 311 through the file system module 305, and writes back the decremented number of usable times to the protected area 311.

In Steps S509 and S510, next, the the-number-of-usable-times determination processing unit 307 determines whether or not usable times (uses) decremented in Step S507 still remain. If it is determined that no more usable times remains, the processing proceeds to Step S511. In Step S511, the the-number-of-usable-times determination processing unit 307 determines that the music data is unusable, regards the music data as data to be deleted, and notifies a deletion processing unit 306 of the location of the music data to be deleted. The deletion processing unit 306 deletes the notified music data from the normal area 312 through the file system module 305, and the processing returns to Step S502.

On the other hand, if it is determined in Step S510 that usable times (uses) still remain, the the-number-of-usable-times determination processing unit 307 determines that the music data is usable and the processing returns to Step S502.

Thus, even in the case where music data stored in an SD card has expired when the SD card is inserted to a host apparatus, the SD card can delete the music data without control of the host apparatus.

In this embodiment, as an example, digital data to be stored in an SD card is music data; however, the present invention is not limited thereto. The present invention is applicable to all kinds of digital data with usable times. Also in this embodiment, as an example, music data is used through a playback operation, and rules for access monitoring are playback start access and playback completion access. After occurrence of the playback completion access, the number of usable times is decremented. However, the present invention is not limited thereto. For example, even when the number of usable times is decremented at a time of access completion such as read of a file or copy of a file, an effect similar to that described in this embodiment can be attained.

### Fifth Embodiment

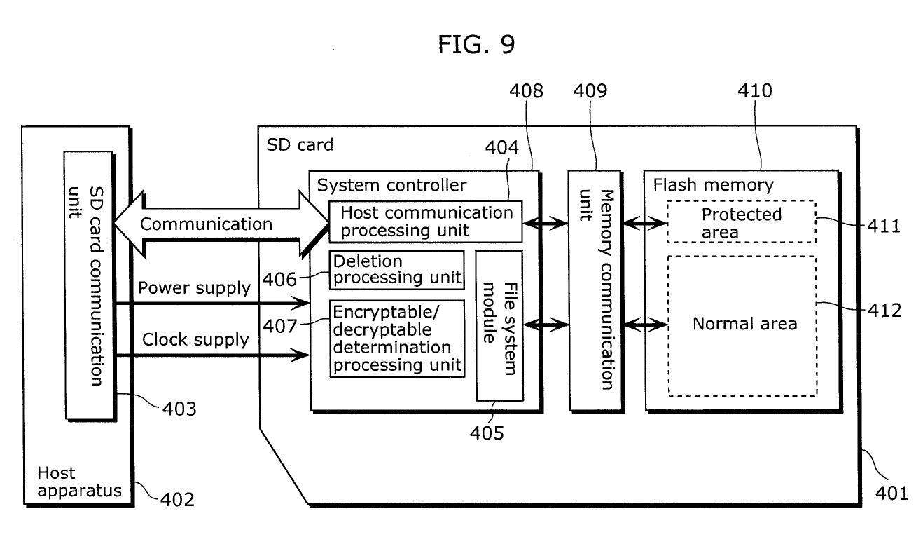

FIG. 9 is a block diagram illustrating a functional structure of an SD card 401 in a fifth embodiment of the present invention and a functional structure of a host apparatus 402 having the SD card 401 insertable thereinto.

In the host apparatus 402, an SD card communication unit 403 detects insertion of the SD card 401, and supplies power and clocks to the inserted SD card 401. Then, the SD card communication unit 403 communicates with the SD card 401 and issues a command to the SD card 401; thus, data is read from/written to the SD card 401.

As illustrated in FIG. 9, the SD card 401 includes a system controller 408, a memory communication unit 409 and a flash memory 410.

The flash memory 410 stores data in a nonvolatile manner. The flash memory 410 is divided into two areas: a normal area 412 and a protected area 411 each storing different kinds of data. The normal area 412, which the host apparatus 402 can access, stores music data. Herein, the music data is encrypted by a key unique to the SD card 401, and can be decrypted correctly only by the key used upon the encryption. The protected area 411, where the host apparatus 402 cannot access directly, stores the key unique to the SD card 401.

The system controller 408 is activated by power and clocks each supplied from the SD card communication unit 403, and controls the SD card 401 entirely.

In the system controller 408, a host communication processing unit 404 analyzes a command issued from the SD card communication unit 403 and communicates with the memory communication unit 409 in accordance with details of the command; thus, the host apparatus 402 can access the flash memory 410.

Through an operation by a file system module 405, data in the flash memory 410 can be recognized as a file.

A deletion processing unit 406 accesses the normal area 412 of the flash memory 410 through the file system module 405 to delete an encrypted music data file.

An encryptable/decryptable determination processing unit 407 accesses the protected area 411 of the flash memory 410 through the file system module 405 to read the SD card unique key and, also, accesses the normal area 412 of the flash memory 410 to read any piece of the encrypted music data. Then, the encryptable/decryptable determination processing unit 407 determines whether or not the music data can be decrypted by the SD card unique key, thereby to determine whether or not the music data is usable.

More specifically, the encryptable/decryptable determination processing unit 407 decrypts at least part of the music data, for example, a portion including a known bit pattern, by means of the SD card unique key. If the bit pattern does not occur, the encryptable/decryptable determination processing unit 307 may determine that the music data is unusable.

This determination is based on the following consideration. In a case that the music data cannot be decrypted by the SD card unique key, that is, in a case that the known bit pattern cannot be obtained by decryption, it is considered that the music data is recorded in the SD card 401 in an unauthorized manner without being encrypted using the SD card unique key.

The memory communication unit 409 accesses the normal area 412 and the protected area 411 in the flash memory 410 to read/write data from/to each area.

In the aforementioned structure, the SD card 401, the encryptable/decryptable determination processing unit 407 and the deletion processing unit 406 respectively correspond to “a recording medium”, “a determination unit” and “a deletion unit” in claims of the present invention.

A procedure of processing executed by the host apparatus 402 in this embodiment is identical to that described in the first embodiment; therefore, specific description thereof will not be given here.

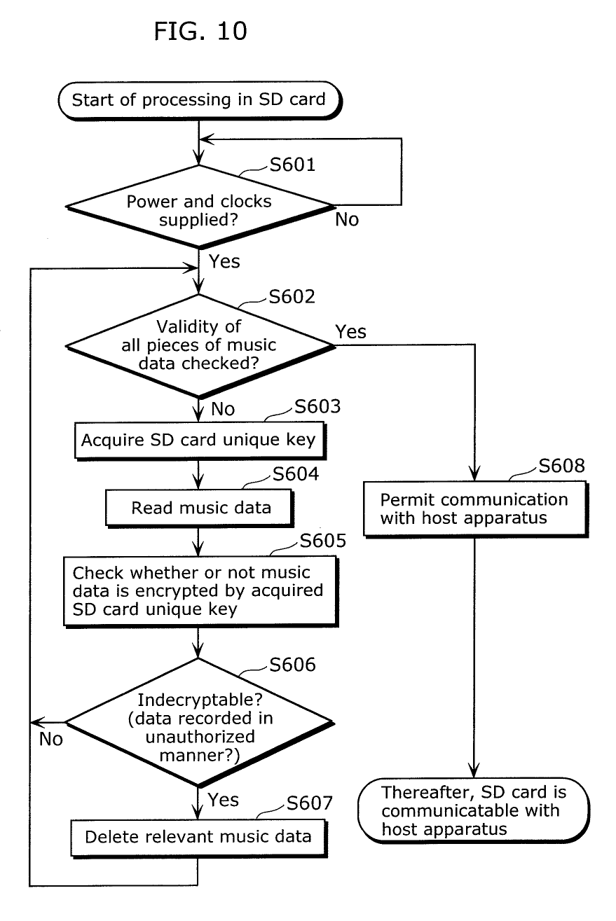

Next, description will be given of a procedure of processing executed by the SD card 401 in this embodiment with reference to a flowchart in FIG. 10.

When the SD card 401 is inserted into the host apparatus 402, thereby to receive power and clocks, the system controller 408 is activated. Then, the system controller 408 checks validity of all pieces of music data stored in the flash memory 410 (that is, checks whether or not each music data is recorded in an unauthorized manner), thereby to determine whether or not the music data is usable. If there is music data recorded in an unauthorized manner, the system controller 408 determines that the music data is unusable and deletes the music data. The host communication processing unit 404 ignores an access command issued from the SD card communication unit 403 until the validity of all pieces of music data is determined and communication permission information is transmitted to the host apparatus 402.

In Step S602, first, the encryptable/decryptable determination processing unit 407 determines whether or not all pieces of music data are valid. If there is undetermined music data, the processing proceeds to Step S603.

Then, the encryptable/decryptable determination processing unit 407 accesses the protected area 411 of the flash memory 410 through the file system module 405 to read an SD card unique key. In Step S604, next, the encryptable/decryptable determination processing unit 407 accesses the normal area 412 of the flash memory 410 through the file system module 405 to read encrypted music data.

In Step S605, next, the encryptable/decryptable determination processing unit 407 determines whether or not the read music data can be decrypted by the SD card unique key. If it is determined in Step S606 that the music data cannot be decrypted, the encryptable/decryptable determination processing unit 407 determines that the music data is unusable data recorded in an unauthorized manner, and the processing proceeds to Step S607. The encryptable/decryptable determination processing unit 407 regards the music data as data to be deleted, and notifies the deletion processing unit 406 of the location of the music data to be deleted. The deletion processing unit 406 deletes the notified music data from the normal area 412 of the flash memory 410 through the file system module 405. On the other hand, if it is determined in Step S606 that the music data can be decrypted, the encryptable/decryptable determination processing unit 407 determines that the music data is usable and the processing returns to Step S602. In Step S602, validity of subsequent music data is checked. If it is determined in Step S602 that the all pieces of music data are valid, the processing proceeds to Step S608. In Step S608, the host communication processing unit 404 transmits communication permission information to the host apparatus 402. Thereafter, the SD card 401 accepts a command issued from the SD card communication unit 403.

Thus, even when music data copied in an unauthorized manner is stored in an SD card, the SD card can delete the music data before communication with a host apparatus.

In this embodiment, as an example, digital data to be stored in an SD card is music data; however, the present invention is not limited thereto. The present invention is applicable to all kinds of digital data encrypted by an SD card unique key. Also in this embodiment, as an example, it is checked whether or not music data encrypted by an SD card unique key can be decrypted, so that the validity of the music data is checked. The present invention also involves that this checking is performed by another well-known technique for detecting data recorded in an unauthorized manner.

### Sixth Embodiment

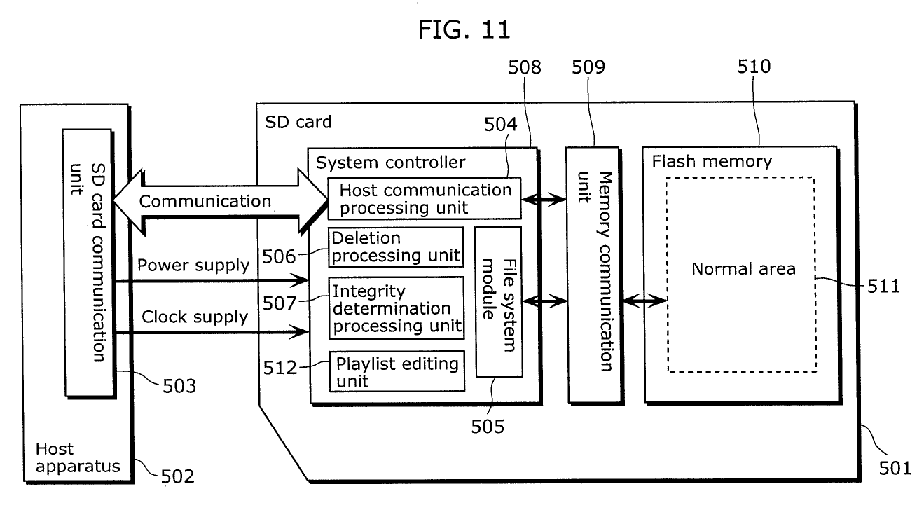

FIG. 11 is a block diagram illustrating a functional structure of an SD card 501 in a sixth embodiment of the present invention and a functional structure of a host apparatus 502 having the SD card 501 insertable thereinto.

In the host apparatus 502, an SD card communication unit 503 detects insertion of the SD card 501, and supplies power and clocks to the inserted SD card 501. Then, the SD card communication unit 503 communicates with the SD card 501 and issues a command to the SD card 501; thus, data is read from/written to the SD card 501.

As illustrated in FIG. 11, the SD card 501 includes a system controller 508, a memory communication unit 509 and a flash memory 510.

The flash memory 510 stores data in a nonvolatile manner. A normal area 511 of the flash memory 510, which the host apparatus 502 can access, stores a music data file having music data held therein. The normal area 511 also stores a playlist information file where the following is described: information indicating each music data (e.g., song title, playing time, artist name, sampling frequency, bit rate and the like), a playback order of music data, and the like. Herein, the information indicating the music data described in the playlist information file corresponds to “management information” in claims of the present invention.

The system controller 508 is activated by power and clocks each supplied from the SD card communication unit 503, and controls the SD card 501 entirely.

In the system controller 508, a host communication processing unit 504 analyzes a command issued from the SD card communication unit 503 and communicates with the memory communication unit 509 in accordance with details of the command; thus, the host apparatus 502 can access the flash memory 510.

Through an operation by a file system module 505, data in the flash memory 510 can be recognized as a file.

A deletion processing unit 506 accesses the normal area 511 of the flash memory 510 through the file system module 505 to delete a music data file.

An integrity determination processing unit 507 accesses the normal area 511 of the flash memory 510 through the file system module 505 to read music data. Then, the integrity determination processing unit 507 determines whether or not a music data file is corrupted, thereby to determine whether or not the relevant music data is to be deleted.

It is assumed herein that music data including information for checking data integrity, for example, parity information or Cyclic Redundancy Code (CRC). The integrity determination processing unit 507 may check the integrity of music data by means of the information, thereby to determine whether or not the music data is corrupted.

A playlist editing unit 512 accesses the normal area 511 of the flash memory 510 through the file system module 505 to edit a playlist information file of music data.

The memory communication unit 509 accesses the normal area 511 of the flash memory 510 to read/write data from/to the normal area 511.

In the aforementioned structure, the SD card 501 corresponds to “a recording medium” in claims of the present invention, the integrity determination processing unit 507 corresponds to “a determination unit” in claims of the present invention, and a combination of the deletion processing unit 506 and the playlist editing unit 512 corresponds to “a deletion unit” in claims of the present invention.

A procedure of processing executed by the host apparatus 502 in this embodiment is identical to that described in the first embodiment; therefore, specific description thereof will not be given here.

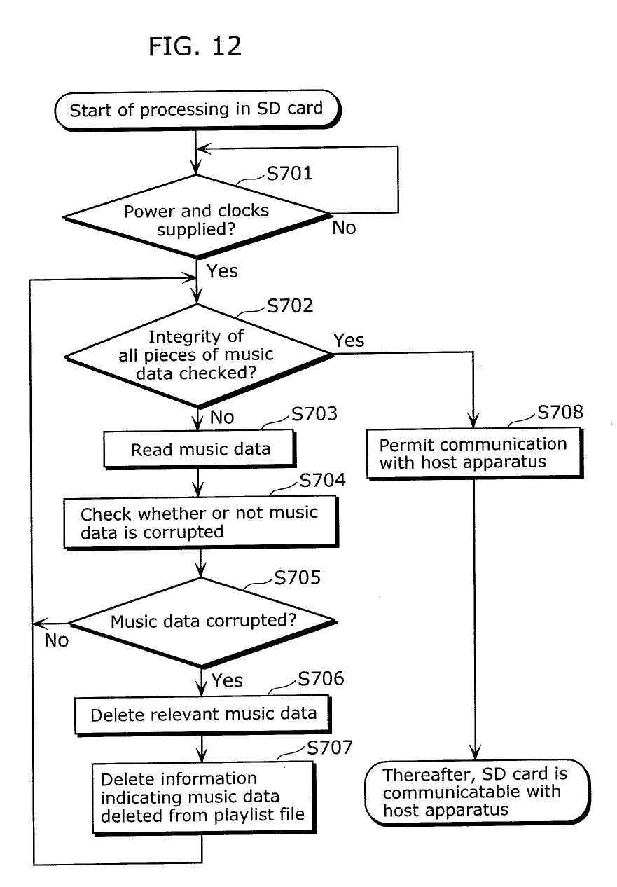

Next, description will be given of a procedure of processing executed by the SD card 501 in this embodiment with reference to a flowchart in FIG. 12.

First, when the SD card 501 is inserted into the host apparatus 502, thereby to receive power and clocks, the system controller 508 is activated to check the integrity of all pieces of music data stored in the flash memory 510 (that is, check whether or not each music data is corrupted). If there is corrupted music data, the system controller 508 deletes the music data. The host communication processing unit 504 ignores an access command issued from the SD card communication unit 503 until the all pieces of music data are determined to be integral and communication permission information is transmitted to the host apparatus 502.

In Step S702, first, the integrity determination processing unit 507 determines whether or not the all pieces of music data are determined to be integral. If there is undetermined music data, the processing proceeds to Step S703.

The integrity determination processing unit 507 accesses the normal area 511 of the flash memory 510 through the file system module 505 to read music data. In Step S704, next, the integrity determination processing unit 507 determines whether or not the read music data is corrupted. If it is determined in Step S705 that the music data is corrupted, the processing proceeds to Step S706. In Step S706, the integrity determination processing unit 507 regards the music data as data to be deleted, and notifies the deletion processing unit 506 of the location of the music data to be deleted.

The deletion processing unit 506 deletes the music data to be deleted from the normal area 511 of the flash memory 510 through the file system module 505. In Step S707, then, the playlist editing unit 512 accesses the normal area 511 of the flash memory 510 through the file system module 505 to delete only information indicating the music data deleted herein from the playlist information file. On the other hand, if it is determined in Step S705 that the music data is not corrupted, the processing returns to Step S702, and the integrity of subsequent music data is checked.

If it is determined in Step S702 that the all pieces of music data are determined to be integral, the processing proceeds to Step S708. In Step S708, the host communication processing unit 504 transmits communication permission information to the host apparatus 502. Thereafter, the SD card 501 accepts a command issued from the SD card communication unit 503.

Thus, even when corrupted music data is stored in an SD card, the SD card can delete the music data before communication with a host apparatus. Further, it is possible to maintain the integrity of a playlist information file storing management information indicating the deleted music data.

In this embodiment, as an example, digital data stored in an SD card is music data; however, the present invention is not limited thereto. The present invention is applicable to all kinds of digital data.

Also in this embodiment, management information indicating music data is included in a playlist information file. Upon deletion of music data, the playlist information file is edited. It is obvious that the present invention is generally applicable irrespective of a fact whether or not a playlist information file includes management information indicating music data to be deleted.

This embodiment describes the procedure to edit a playlist information file including management information indicating corrupted music data. This procedure is applicable to each of the first to fifth embodiments if there is data information indicating music data to be deleted.

### Seventh Embodiment

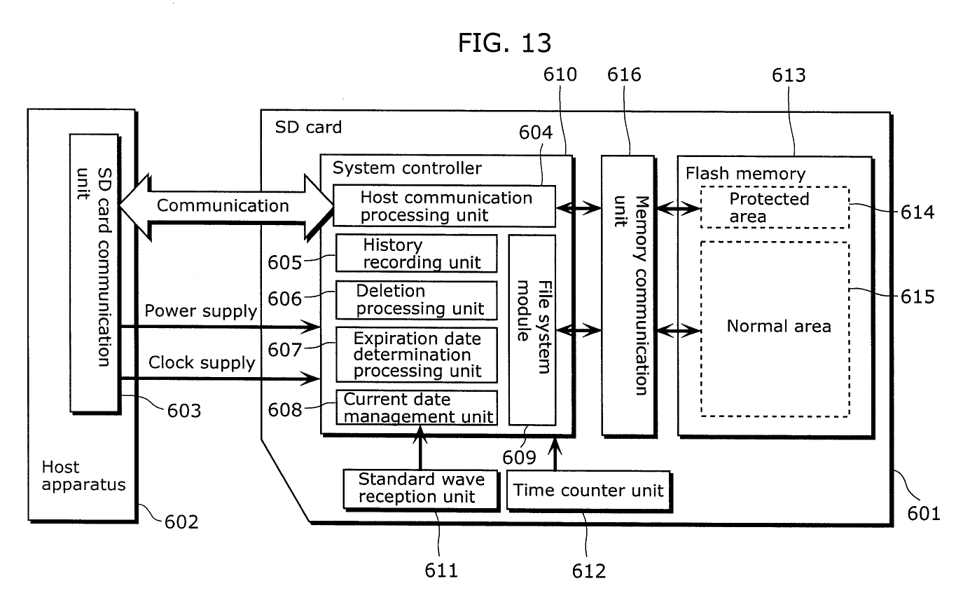

FIG. 13 is a block diagram illustrating a functional structure of an SD card 601 in a seventh embodiment of the present invention and a functional structure of a host apparatus 602 having the SD card 601 insertable thereinto.

In the host apparatus 602, an SD card communication unit 603 detects insertion of the SD card 601, and supplies power and clocks to the inserted SD card 601. Then, the SD card communication unit 603 communicates with the SD card 601 and issues a command to the SD card 601; thus, data is read from/written to the SD card 601.

As illustrated in FIG. 13, the SD card 601 includes a system controller 610, a standard wave reception unit 611, a time counter unit 612, a memory communication unit 616 and a flash memory 613.

The flash memory 613 stores data in a nonvolatile manner. The flash memory 613 is divided into two areas: a normal area 615 and a protected area 614 each storing different kinds of data. The normal area 615, which the host apparatus 602 can access, stores music data. The protected area 614, where the host apparatus 602 cannot access directly, stores expiration dates of all pieces of music data stored in the normal area 615.

The system controller 610 is activated by power and clocks each supplied from the SD card communication unit 603, and controls the SD card 601 entirely.

In the system controller 610, a host communication processing unit 604 analyzes a command issued from the SD card communication unit 603 and communicates with the memory communication unit 616 in accordance with details of the command; thus, the host apparatus 602 can access the flash memory 613.

Through an operation by a file system module 609, data in the flash memory 613 can be recognized as a file.

A deletion processing unit 606 accesses the normal area 615 of the flash memory 613 through the file system module 609 to delete a music data file.

An expiration date determination processing unit 607 accesses the protected area 614 of the flash memory 613 through the file system module 609 to acquire an expiration date of any piece of the music data. Then, the expiration date determination processing unit 607 compares the expiration date with a current date acquired from a current date management unit 608, thereby to determine whether or not the relevant music data is usable.

The current date management unit 608 acquires a current date from the standard wave reception unit 611, and notifies the expiration date determination processing unit 607 of the current date.

The standard wave reception unit 611 acquires a current date based on a received standard wave for time tone, and notifies the current date management unit 608 of the current date.

The memory communication unit 616 accesses the normal area 615 and the protected area 614 in the flash memory 613 to read/write data from/to each area.

The time counter unit 612 can measure a fixed time, and notifies the system controller 610 of a lapse of an arbitrary time.

When the deletion processing unit 606 deletes music data, a history recording unit 605 records deletion information indicating the deletion of the music data in a data deletion information file in the normal area 615 of the flash memory 613 through the file system module 609.

In the aforementioned structure, the SD card 601, the expiration date determination processing unit 607, the deletion processing unit 606 and the history recording unit 605 respectively correspond to “a recording medium”, “a determination unit”, “a deletion unit” and “a recording unit” in claims of the present invention.

A procedure of processing executed by the host apparatus 602 in this embodiment is identical to that described in the first embodiment; therefore, specific description thereof will not be given here.

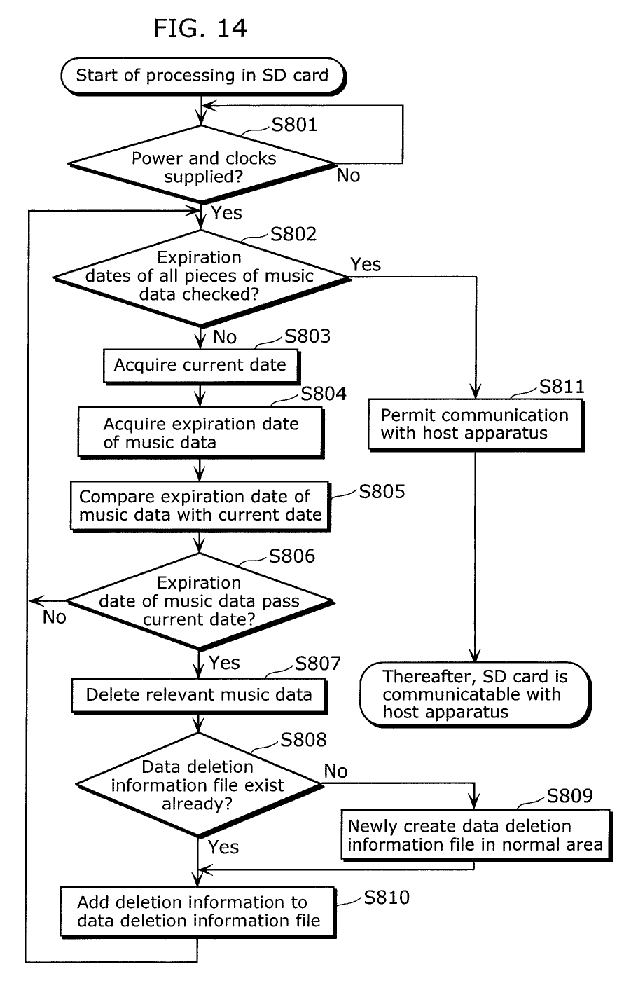

Next, description will be given of a procedure of processing executed by the SD card 601 in this embodiment with reference to a flowchart in FIG. 14.

In Step S801, first, the SD card 601 enters a power/clock reception standby state. When the SD card 601 is inserted into the host apparatus 602, thereby to receive power and clocks, the system controller 610 is activated to compare a current date with each of expiration dates of all pieces of music data stored in the normal area 615 of the flash memory 613. If there is music data with an expiration date passing the current date, the system controller 610 determines that the music data is unusable and deletes the music data. The host communication processing unit 604 ignores an access command issued from the SD card communication unit 603 until the expiration dates of all pieces of music data are determined and communication permission information is transmitted to the host apparatus 602.

In Step S802, next, the expiration date determination processing unit 607 determines that the expiration dates of all pieces of music data are determined. If there is undetermined music data, the processing proceeds to Step S803.

In Step S803, the current date management unit 608 acquires a current date from the standard wave reception unit 611 and notifies the expiration date determination processing unit 607 of the current date. In Step S804, next, the expiration date determination processing unit 607 accesses the protected area 614 through the file system module 609 to acquire the expiration date of the relevant music data.

In Step S805, next, the expiration date determination processing unit 607 compares the current date with the acquired expiration date. If it is determined that the expiration date does not pass the current date, the expiration date determination processing unit 607 determines that the music data is usable and the processing returns to Step S802. On the other hand, if it is determined that the expiration date passes the current date, the processing proceeds to Step S807. In Step S807, the expiration date determination processing unit 607 determines that the music data is unusable, regards the music data as data to be deleted, and notifies the deletion processing unit 606 of the location of the music data to be deleted.

The deletion processing unit 606 deletes the notified music data from the normal area 615 through the file system module 609.

In Step S808, next, the history recording unit 605 accesses the normal area 615 through the file system module 609 to determine whether or not there is a data deletion information file in the normal area 615. If there is no data deletion information file, the processing proceeds to Step S809. In Step S809, the history recording unit 605 newly creates a data deletion information file in the normal area 615 through the file system module 609.

On the other hand, if there is a data deletion information file, the processing proceeds to Step S810. In Step S810, the history recording unit 605 acquires a file name of the deleted music data from the deletion processing unit 606, acquires the expiration date of the deleted music data from the expiration date determination processing unit 607 and acquires the current date from the current date management unit 608. Then, the history recording unit 605 accesses the normal area 615 through the file system module 609 to additionally write deletion information to the data deletion information file. This deletion information may include acquired information in the following forms, for example.

1. Acquired file name (as identification name of music data)

2. Acquired expiration date (as use rule of music data)

3. Acquired current date (as date of deletion)

4. Reason for deletion (e.g., expiration)

Next, the processing returns to Step S802. In Step S802, comparison for subsequent music data is performed. After completion of determining the expiration dates of all pieces of music data in Step S802, the processing proceeds to Step S811. In Step S811, the host communication processing unit 604 transmits communication permission information to the host apparatus 602. Thereafter, the SD card 601 accepts a command issued from the SD card communication unit 603.

Thus, even when expired music data is stored in an SD card, the SD card can delete the music data before communication with a host apparatus. Further, recording of deletion information makes it possible to check information indicating deletion of music data at any moment. Such check information includes reason for deletion.

In this embodiment, as an example, expired music data is deleted at timing that the SD card 601 is inserted into the host apparatus 602. However, as described in the first to sixth embodiments, it may be considered that music data is deleted based on another reason (e.g., no more usable times, unauthorized recording, and corruption) at another timing (e.g., periodical monitoring, and access request from host apparatus).

Therefore, it is desirable that deletion information to be recorded includes deletion timing and reasons for deletion other than “expired”. Alternatively, deletion information to be recorded may include other information such as a file size.

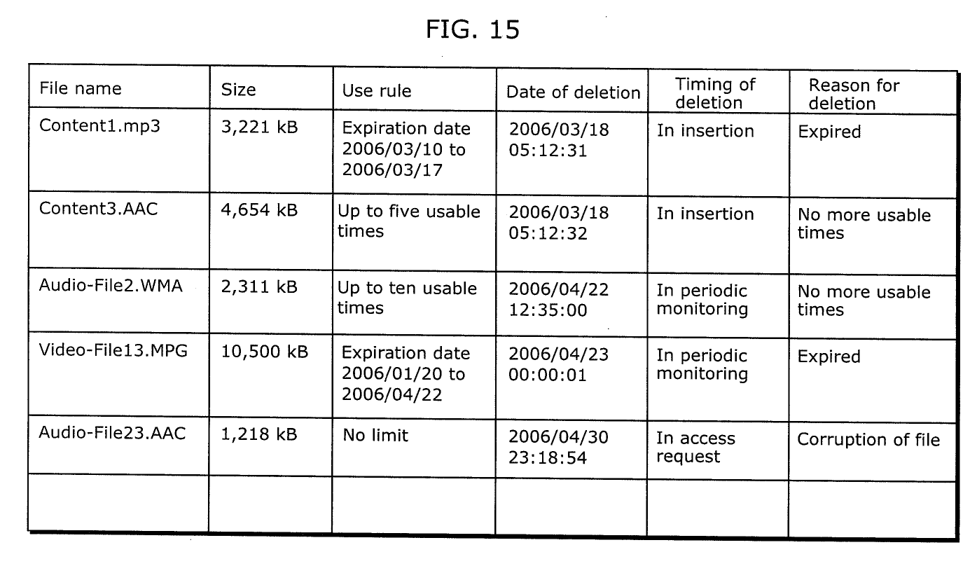

FIG. 15 shows examples of deletion information written to a data deletion information file.

Moreover, deletion information is not additionally written to a data deletion information file, but may be additionally written to management information described in a playlist information file in the sixth embodiment. As described above, management information indicating music data is described in the playlist information file. Therefore, when music data is deleted, deletion information can be additionally written to the management information with ease.

### Eighth Embodiment

In an eighth embodiment of the present invention, a structure of an SD card 601 and a structure of a host apparatus 602 having the SD card 601 inserted thereinto are identical to those described in the seventh embodiment with reference to FIG. 13. As for the SD card 601 in this embodiment, when music data is determined as usable data or unusable data, determination information indicating the determination is recorded in a data determination information file in a normal area 615 of a flash memory 613.

A procedure of processing executed by the host apparatus 602 in this embodiment is identical to that described in the first embodiment; therefore, specific description thereof will not be given here.

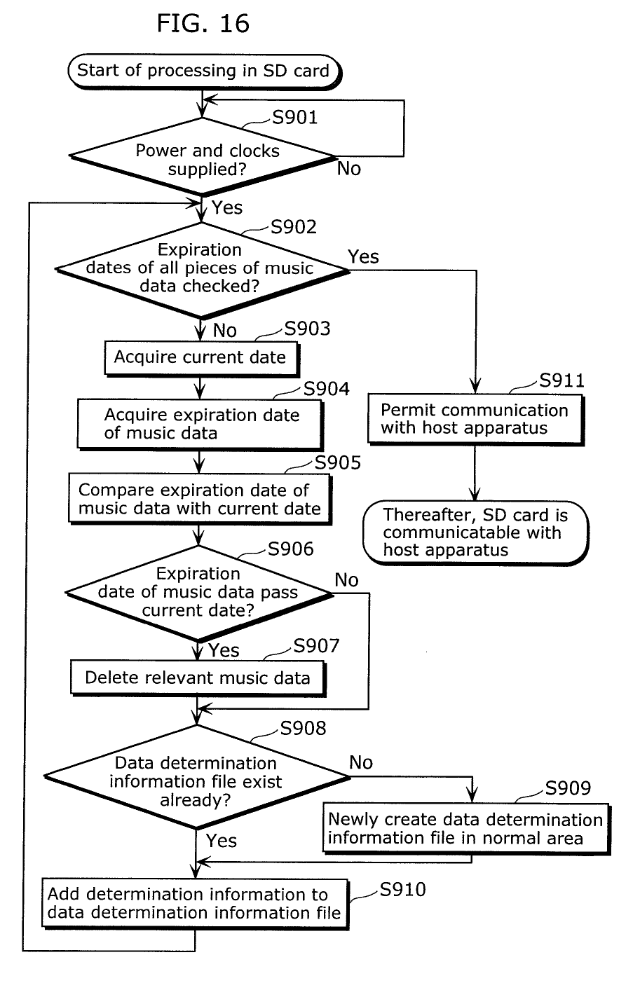

Description will be given of a procedure of processing executed by the SD card 601 in this embodiment with reference to a flowchart in FIG. 16.

In Step S901, first, the SD card 601 enters a power/clock reception standby state. When the SD card 601 is inserted into the host apparatus 602, thereby to receive power and clocks, a system controller 610 is activated to compare a current date with each of expiration dates of all pieces of music data stored in the normal area 615 of the flash memory 613. If there is music data with an expiration date passing the current date, the system controller 610 determines that the music data is unusable and deletes the music data. A host communication processing unit 604 ignores an access command issued from an SD card communication unit 603 until the expiration dates of all pieces of music data are determined and communication permission information is transmitted to the host apparatus 602.

In Step S902, next, an expiration date determination processing unit 607 determines whether or not the expiration dates of all pieces of music data are determined. If there is undetermined music data, the processing proceeds to Step S903.

In Step S903, a current date management unit 608 acquires a current date from a standard wave reception unit 611 and notifies the expiration date determination processing unit 607 of the current date. In Step S904, next, the expiration date determination processing unit 607 accesses a protected area 614 through a file system module 609 to acquire the expiration date of the relevant music data. In Step S905, next, the expiration date determination processing unit 607 compares the current date with the acquired expiration date. If it is determined that the expiration date passes the current date, the processing proceeds to Step S907. In Step S907, the expiration date determination processing unit 607 determines that the music data is unusable, regards the music data as data to be deleted, and notifies a deletion processing unit 606 of the location of the music data to be deleted. The deletion processing unit 606 deletes the notified music data from the normal area 615 through the file system module 609.

Then, the processing proceeds to Step S908 irrespective of a fact whether or not the music data is deleted. In Step S908, a history recording unit 605 accesses the normal area 615 through the file system module 609 to determine whether or not there is a data determination information file in the normal area 615. If there is no data determination information file, the processing proceeds to Step S909. In Step S909, the history recording unit 605 newly creates a data determination information file in the normal area 615 through the file system module 609.

On the other hand, if there is a data determination information file in the normal area 615, the processing proceeds to Step S910. In Step S910, the history recording unit 605 acquires a current date from the current date management unit 608. Further, the history recording unit 605 acquires a file name, an expiration date and a result of the determination of the music data from the expiration date determination processing unit 607. The result of the determination acquired herein includes a remaining expiration period if it is determined that the music data is usable. On the other hand, the result of the determination represents a reason for deletion if it is determined that the music data is unusable. Then, the history recording unit 605 accesses the normal area 615 through the file system module 609 to additionally write the determination information to the data determination information file. This determination information may include acquired information in the following forms, for example.

1. Acquired file name (as identification name of music data)

2. Acquired expiration date (as use rule of music data)

3. Acquired current date (as determination date)

4. Acquired result of determination (remaining expiration period or reason for deletion)

Next, the processing returns to Step S902. In Step S902, comparison for subsequent music data is performed. After completion of checking the expiration dates of all pieces of music data in Step S902, the processing proceeds to Step S911. In Step S911, the host communication processing unit 604 transmits communication permission information to the host apparatus 602. Thereafter, the SD card 601 accepts a command issued from the SD card communication unit 603.

Thus, even when expired music data is stored in an SD card, the SD card can delete the music data before communication with a host apparatus. Further, recording of determination information makes it possible to check information indicating determination of usable/unusable of music data, for example, a result of determination, at any moment.

In this embodiment, as an example, it is determined whether or not music data is usable based on an expiration date at timing that the SD card 601 is inserted into the host apparatus 602. However, as described in the first to sixth embodiments, it may be considered that it is determined whether or not music data is usable based on another determination requirement (e.g., the number of usable times, unauthorized recording, and corruption) at another timing (e.g., periodical monitoring, and access request from host apparatus).

Therefore, it is desirable that determination information to be recorded includes determination timing and determination requirements other than an expiration date. Alternatively, determination information to be recorded may include other information such as a file size.

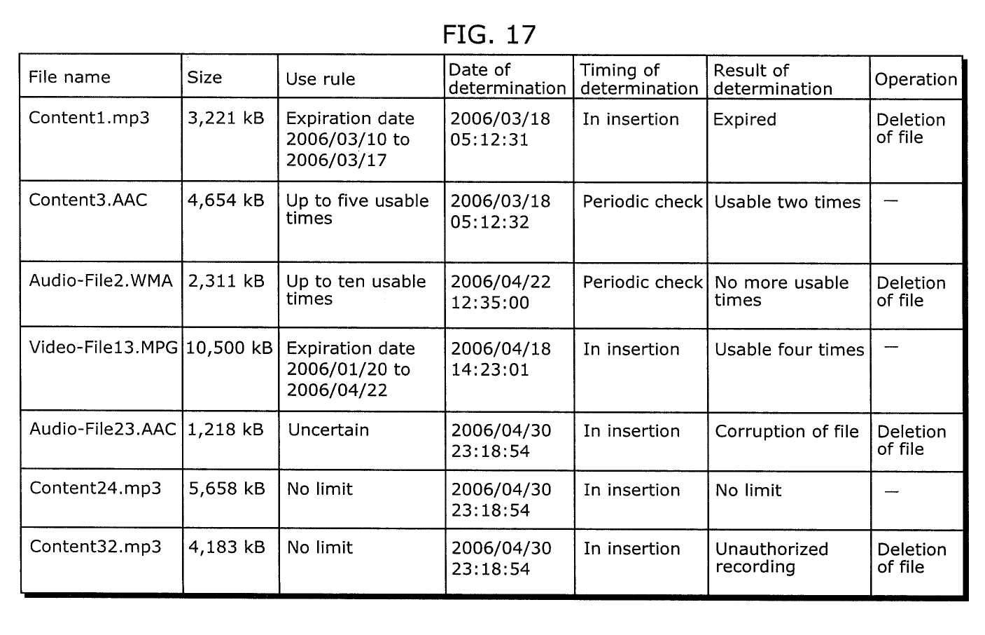

FIG. 17 shows examples of determination information written to a data determination information file.

### Ninth Embodiment

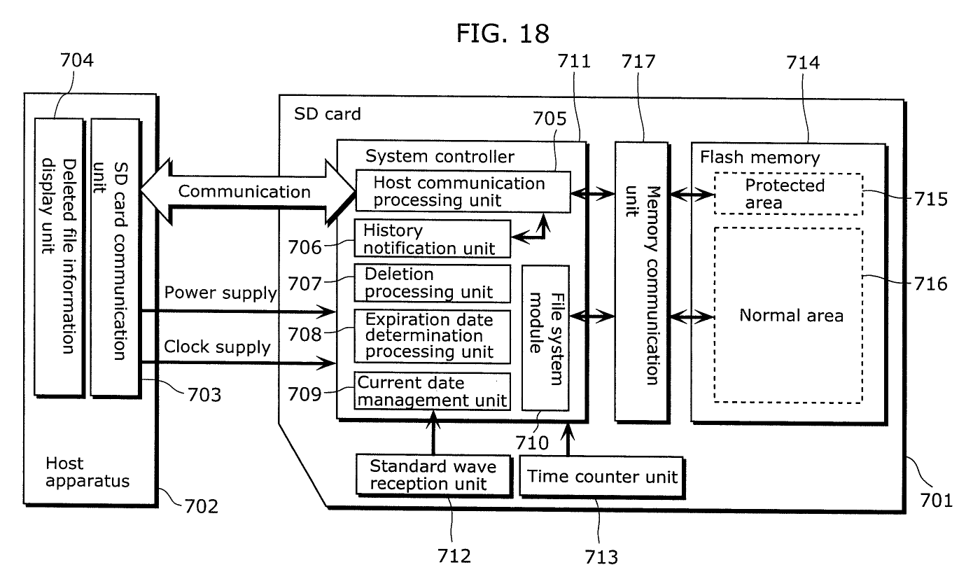

FIG. 18 is a block diagram illustrating a functional structure of an SD card 701 in a ninth embodiment of the present invention and a functional structure of a host apparatus 702 having the SD card 701 insertable thereinto.

In the host apparatus 702, an SD card communication unit 703 detects insertion of the SD card 701, and supplies power and clocks to the inserted SD card 701. Then, the SD card communication unit 703 communicates with the SD card 701 and issues a command to the SD card 701; thus, data is read from/written to the SD card 701. A deleted file information display unit 704 acquires deleted file information from the SD card communication unit 703, and displays the deleted file for a user.

Herein, the deleted file information is transmitted from the SD card 701, and includes a file name, date of deletion, reason for deletion and the like of a file deleted based on autonomous determination by the SD card 701.

As illustrated in FIG. 18, the SD card 701 includes a system controller 711, a standard wave reception unit 712, a time counter unit 713, a memory communication unit 717 and a flash memory 714.

The flash memory 714 stores data in a nonvolatile manner. The flash memory 714 is divided into two areas: a normal area 716 and a protected area 715 each storing different kinds of data. The normal area 716, which the host apparatus 702 can access, stores music data. The protected area 715, where the host apparatus 702 cannot access directly, stores expiration dates of all pieces of music data stored in the normal area 716.

The system controller 711 is activated by power and clocks each supplied from the SD card communication unit 703, and controls the SD card 701 entirely.

In the system controller 711, a host communication processing unit 705 analyzes a command issued from the SD card communication unit 703 and communicates with the memory communication unit 717 in accordance with details of the command; thus, the host apparatus 702 can access the flash memory 714.

Through an operation by a file system module 710, data in the flash memory 714 can be recognized as a file.

A deletion processing unit 707 accesses the normal area 716 of the flash memory 714 through the file system module 710 to delete a music data file.

An expiration date determination processing unit 708 accesses the protected area 715 of the flash memory 714 through the file system module 710 to acquire an expiration date of any piece of the music data. Then, the expiration date determination processing unit 708 compares the expiration date with a current date acquired from a current date management unit 709, thereby to determine whether or not the relevant music data is usable.

The current date management unit 709 acquires a current date from the standard wave reception unit 712, and notifies the expiration date determination processing unit 708 of the current date.

The standard wave reception unit 712 acquires a current date based on a received standard wave for time tone, and notifies the current date management unit 709 of the current date.

The memory communication unit 717 accesses the normal area 716 and the protected area 715 in the flash memory 714 to read/write data from/to each area.

The time counter unit 713 can measure a fixed time, and notifies the system controller 711 of a lapse of an arbitrary time.

A history notification unit 706 acquires a file name from the deletion processing unit 707 and acquires a current date from the current date management unit 709, thereby to create deleted file information. Then, the history notification unit 706 transmits the deleted file information to the host apparatus 702 through the host communication processing unit 705.

In the aforementioned structure, the SD card 701, the expiration date determination processing unit 708, the deletion processing unit 707 and the history notification unit 706 respectively correspond to “a recording medium”, “a determination unit”, “a deletion unit” and “a notification unit” in claims of the present invention.

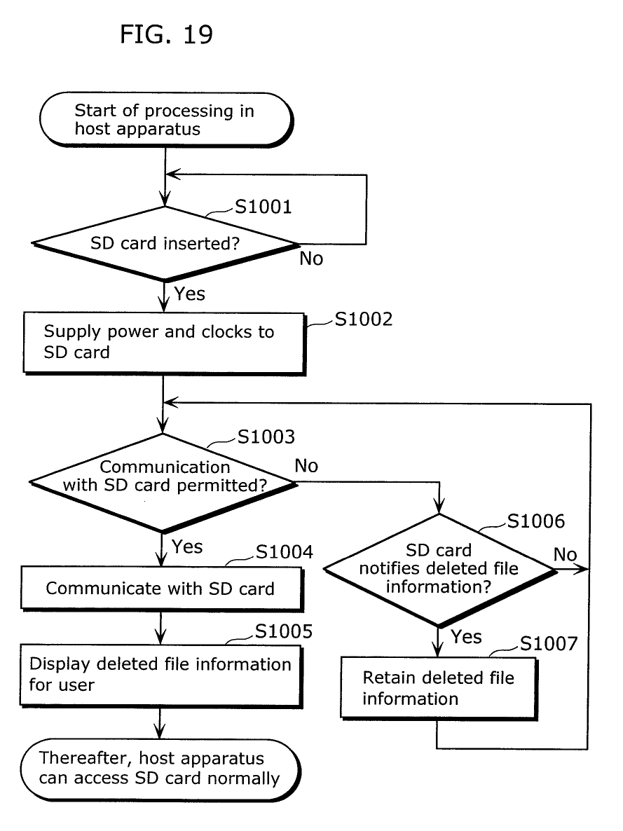

Next, description will be given of a procedure of processing executed by the host apparatus 702 in this embodiment with reference to a flowchart in FIG. 19.

In Step S1001, first, the host apparatus 702 enters an SD card insertion standby state. When the SD card 701 is inserted into the host apparatus 702, the processing proceeds to Step S1002. In Step S1002, the SD card communication unit 703 supplies power and clocks to the inserted SD card 701.

Subsequently, the processing enters a loop until the SD card 701 transmits communication permission information to the host apparatus 702. In Step S1003, the host apparatus 702 enters a communication permission information reception standby state. Herein, if the host apparatus 702 receives no communication permission information from the SD card 701, the processing proceeds to Step S1006. In Step S1006, the host apparatus 702 monitors transmission of deleted file information from the SD card 701. Upon reception of the deleted file information, the host apparatus 702 sends the received information to the deleted file information display unit 704. The deleted file information display unit 704 stores the deleted file information until communication between the SD card 701 and the host apparatus 702 is permitted. In the host apparatus 702, the aforementioned processes are repeatedly executed until reception of communication permission information.

Upon reception of the communication permission information from the SD card 701, the processing proceeds to Step S1005. In Step S1005, the deleted file information display unit 704 displays the deleted file information stored therein for a user. Thereafter, the host apparatus 702 can communicate with the SD card 701.

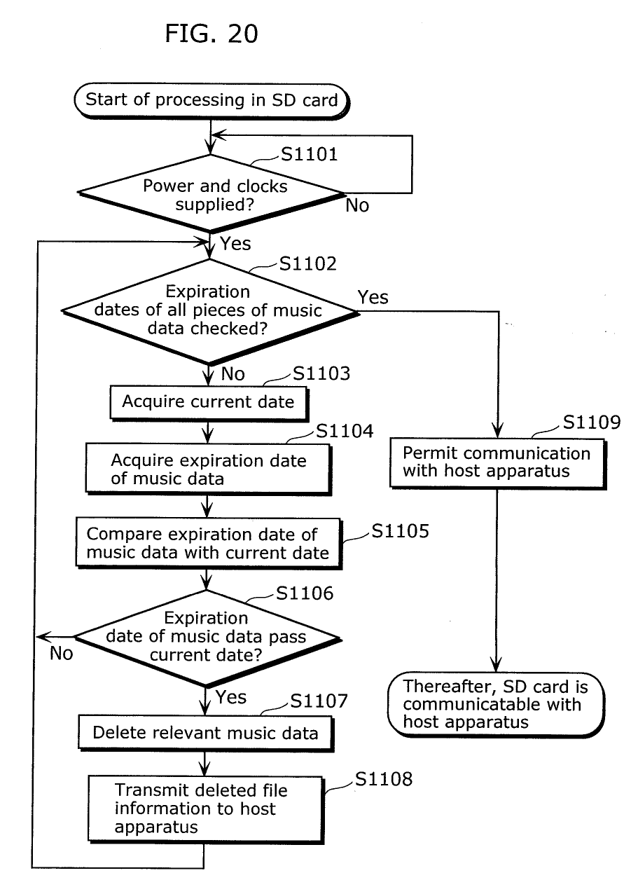

Next, description will be given of a procedure of processing executed by the SD card 701 in this embodiment with reference to a flowchart in FIG. 20.

In Step S1101, first, the SD card 701 enters a power/clock reception standby state. When the SD card 701 is inserted into the host apparatus 702, thereby to receive power and clocks, the system controller 711 is activated to compare a current date with each of expiration dates of all pieces of music data stored in the normal area 716 of the flash memory 714. If there is music data with an expiration date passing the current date, the system controller 711 determines that the music data is unusable and deletes the music data. The host communication processing unit 705 ignores an access command issued from the SD card communication unit 703 until the expiration dates of all pieces of music data are determined and communication permission information is transmitted to the host apparatus 702.

In Step S1102, next, the expiration date determination processing unit 708 determines whether or not the expiration dates of all pieces of music data are determined. If there is undetermined music data, the processing proceeds to Step S1103.

In Step S1103, the current date management unit 709 acquires a current date from the standard wave reception unit 712 and notifies the expiration date determination processing unit 708 of the current date. In Step S1104, next, the expiration date determination processing unit 708 accesses the protected area 715 through the file system module 710 to acquire the expiration date of the relevant music data. In Step S1105, next, the expiration date determination processing unit 708 compares the current date with the acquired expiration date. If it is determined that the expiration date does not pass the current date, the expiration date determination processing unit 708 determines that the music data is usable and the processing returns to Step S1102. On the other hand, if it is determined that the expiration date passes the current date, the processing proceeds to Step S1107. In Step S1107, the expiration date determination processing unit 708 determines that the music data is unusable, regards the music data as data to be deleted, and notifies the deletion processing unit 707 of the location of the music data to be deleted.

The deletion processing unit 707 deletes the notified music data from the normal area 716 through the file system module 710.

In Step S1108, next, the history notification unit 706 acquires a current date from the current date management unit 709, acquires an expiration date of the music data from the expiration date determination processing unit 708, and acquires a file name of the deleted music data from the deletion processing unit 707. Then, the history notification unit 706 creates deleted file information based on the acquired information, and transmits the deleted file information to the host apparatus 702 through the host communication processing unit 705. This deleted file information may include the acquired information in the following forms, for example.

1. Acquired file name (as identification name of music data)

2. Acquired expiration date (as use rule of music data)

3. Acquired current date (as date of deletion)

4. Reason for deletion (e.g., expiration)

Next, the processing returns to Step S1102. In Step S1102, comparison for subsequent music data is performed. After completion of determining the expiration dates of all pieces of music data in Step S1102, the processing proceeds to Step S1109. In Step S1109, the host communication processing unit 705 transmits communication permission information to the host apparatus 702. Thereafter, the SD card 701 accepts a command issued from the SD card communication unit 703.

Thus, even when expired music data is stored in an SD card, the SD card can delete the music data before communication with a host apparatus. Further, notification indicating deleted file information to the host apparatus makes it possible to provide information indicating deletion of music data, for example, reasons for deletion, to a user through the host apparatus.

In this embodiment, as an example, expired music data is deleted at timing that the SD card 701 is inserted into the host apparatus 702. However, as described in the first to sixth embodiments, it may be considered that music data is deleted based on another reason (e.g., no more usable times, illegal recording, and corruption) at another timing (e.g., periodical monitoring, and access request from host apparatus).

Therefore, it is desirable that deleted file information is transmitted to the host apparatus according to circumstances. Alternatively, deleted file information including other information such as a file size may be transmitted to the host apparatus. Such deleted file information may be equal to the deletion information described in the seventh embodiment.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The removable medium according to the present invention makes it possible to facilitate management of contents with a specified use rule and to securely protect copyright of such contents.

What is claimed is:

1. A recording medium which is insertable into and removable from plural host apparatuses and includes digital data recorded therein, said recording medium comprising:
a determination unit operable to determine whether or not the digital data is usable; and
a deletion unit operable to delete the digital data when it is determined that the digital data is unusable.

2. The recording medium according to claim 1,
wherein said recording medium includes information indicating an expiration date of the digital data recorded therein,
said determination unit is operable to determine whether or not the digital data has expired based on the information, and
said deletion unit is operable to delete the digital data when it is determined that the digital data has expired.

3. The recording medium according to claim 1,
wherein said recording medium includes information indicating the number of usable times of the digital data recorded therein,
said determination unit is operable to determine whether or not no more uses of the digital data remains based on the information, and
said deletion unit is operable to delete the digital data when it is determined that no more uses of the digital data remains.

4. The recording medium according to claim 1,
wherein said recording medium includes medium unique key information recorded therein,
said determination unit is operable to determine whether or not the digital data is recorded in said recording medium in an unauthorized manner by decoding at least part of the digital data based on the medium unique key information, and
said deletion unit is operable to delete the digital data when it is determined that the digital data is recorded in an unauthorized manner.

5. The recording medium according to claim 1,
wherein the digital data includes information for checking data integrity,
said determination unit is operable to check the integrity of the digital data based on the information, thereby to determine whether or not the digital data is corrupted, and
said deletion unit is operable to delete the digital data when it is determined that the digital data is corrupted.

6. The recording medium according to claim 1,
wherein said determination unit is operable to make the determination when said recording medium receives operating power, and
said deletion unit is operable to perform the deletion prior to a first response to an access request from outside.

7. The recording medium according to claim 1,
wherein said determination unit is operable to make the determination periodically during a period in which said recording medium receives operating power.

8. The recording medium according to claim 1,
wherein said determination unit is operable to make the determination upon acceptance of an access request from outside, and
said deletion unit is operable to perform the deletion prior to a response to the access request.

9. The recording medium according to claim 1,
wherein said recording medium includes management information indicating the digital data recorded therein, and
said deletion unit is operable to edit the management information upon deletion of the digital data.

10. The recording medium according to claim 1, further comprising
a recording unit, when said deletion unit deletes the digital data, operable to record deletion information including an identification name, a use rule, and a date of the deletion of the deleted digital data.

11. The recording medium according to claim 10,
wherein said recording medium includes management information indicating the digital data recorded therein, and
said recording unit is operable to add the deletion information to the management information.

12. The recording medium according to claim 1, further comprising
a recording unit, when said determination unit determines whether or not the digital data is usable, operable to record determination information including an identification name, a use rule, a date of the determination, and a result of the determination of the determined digital data.

13. The recording medium according to claim 1, further comprising
a notification unit, when said deletion unit deletes the digital data, operable to notify a host apparatus, into which said recording medium is inserted, of deletion information including an identification name, a use rule, and a date of the deletion of the deleted digital data.

14. A data management method performed in a recording medium which is insertable into/removable from plural host apparatuses and includes digital data recorded therein, said data management method comprising:
determining whether or not the digital data is usable; and
deleting the digital data when it is determined that the digital data is unusable.

15. A computer program product mounted onto a recording medium which is insertable into and removable from plural host apparatuses and holding digital data, the product allowing a computer included in the recording medium to execute:
determining whether or not the digital data is usable; and
deleting the digital data when it is determined that the digital data is unusable.
